(19) United States
(12) Patent Application Publication
(10) Pub. No.: US 2015/0290646 A1
(43) Pub. Date: Oct. 15, 2015

(54) MODULAR LABORATORY FURNITURE SYSTEM

(71) Applicants: CIF Lab Solutions, LP, Vaughan (CA); Steven Rosenstein Associates Inc. D/B/A SRA Consultants, Boca Raton, FL (US)

(72) Inventors: Steven Rosenstein, Pawling, NY (US); Bert Walter Bowden, Uxbridge, MA (US)

(73) Assignees: CIF Lab Solutions, LP, Vaughan (CA); Steven Rosenstein Associates Inc. D/B/A SRA Consultants, Boca Raton, FL (US)

(21) Appl. No.: 14/684,802

(22) Filed: Apr. 13, 2015

Related U.S. Application Data
(60) Provisional application No. 61/979,556, filed on Apr. 15, 2014.

(51) Int. Cl. B01L 9/02; A47B 81/00; A47B 83/00; A47B 87/00

(52) U.S. Cl. CPC B01L 9/02; A47B 87/00; A47B 81/00; A47B 83/001; A47B 2083/003

(57) ABSTRACT

A modular laboratory system that facilitates lower cost installation and reconfiguration of laboratory furniture includes a core unit adapted for releasably docking with a mobile modular laboratory furniture unit. The core unit includes a top member supported on a frame and at least one chase-way extending upwardly from the top member. The chase-way includes walls defining the sides of an enclosure for plumbing connecting a service fitting mounted through a wall of the chase-way to a coupling at a top end of the chase-way, whereby a service supply line can be connected to the coupling to provide service to the service fitting.

### CROSS-REFERENCE TO RELATED APPLICATION

This application claims priority to U.S. Provisional Patent Application No. 61/979,556 filed on Apr. 15, 2014, which is hereby incorporated by reference in its entirety.

### FIELD OF THE DISCLOSURE

This disclosure relates to laboratory furniture and more particularly to laboratory furniture that can be easily installed, dismantled and reconfigured.

### BACKGROUND OF THE DISCLOSURE

Laboratory furniture installation has involved substantial time and labor on site, leading to high costs and disruptions for new installations in existing facilities and reconfiguration of installed laboratory furniture. Known modular laboratory furniture systems allow the various laboratory desks, benches, sinks, and other furniture to be reconfigured. However, these known modular laboratory furniture systems generally require very substantial on site plumbing and electrical work to connect gases (e.g., natural gas, inert gas, etc.) to gas supply outlets on the laboratory furniture and wiring to electrical terminals or outlets on the laboratory furniture. Such installations and reconfigurations can take several days or even weeks. An improved modular laboratory furniture system 10 that overcomes some of the problems associated with on site plumbing and electrical work is shown in FIG. 1. In this system, an overhead service carrier 12 is fixed to and supported from a ceiling or other overhead structure, and flexible conduits 14 having quick-connect couplings 16 are used for reducing the amount of on-site labor needed for reconfiguring a laboratory.

Reconfiguration can involve simply disconnecting flexible conduits 14 from the overhead service carrier 12 and furniture modules 18, reconfiguring furniture modules as desired then connecting the new or repositioned furniture modules to the desired services available in the overhead service carrier 12 using flexible conduits 14 and quick-connect couplings 16. While the overhead service carrier and quick-connect couplings reduce the time required for installing, dismantling and reconfiguring a laboratory system, installation and plumbing of the overhead service carrier 12 is an added expense that off-sets some of the time and labor savings associated with the use of flexible conduits 14 and quick-connect couplings 16. Additionally, exposed conduits 14 do not necessarily provide optimized aesthetics.

Accordingly, an object of the disclosed system is to further reduce the on-site time and labor associated with installing, dismantling and reconfiguring modular laboratory furniture, while providing improved aesthetics in which service connections are concealed in a utility chase.

### SUMMARY OF THE DISCLOSURE

Disclosed is a modular laboratory system that reduces the time and labor needed to install laboratory furniture in a new facility and to reconfigure or renovate an existing facility. The system includes a core unit including a base having a top member supported on a frame and at least one chase-way projecting upwardly from the top. The chase-way is pre-plumbed with conduit connecting a service fitting with a coupling at the top end of the chase-way to reduce on-site plumbing labor for connection of the coupling to a service supply line.

In certain aspects, the disclosed laboratory systems can include first and second chase-ways located at opposite ends of the top member. One or more shelves can be supported between the chase-ways to provide storage area and structurally stabilize the chase-ways.

Various modular furniture units, such as adjustable height tables and mobile workstations (e.g., having wheels, rollers, castors or the like), can be docked with the core unit. Services, power or both can be provided to the docked modular units from the core unit via flexible conduit connections or power cables.

The chase-way can have a hinged door or removable access panel to provide access into the chase-way, such as to add a service.

To facilitate lateral docking of the core unit with powered workstation modules, a vertically arranged electrical raceway can be mounted on the access panel or hinged door.

These and other features, advantages and objects of the various embodiments will be better understood with reference to the following specification and claims.

### BRIEF DESCRIPTION OF THE DRAWINGS

FIG. 1 is a perspective view showing a conventional modular laboratory system in which workstations are provided services from an overhead service carrier via flexible tubing having quick-connect couplings.

FIG. 1A is a perspective view of a flexible conduit with a quick connect coupling.

FIG. 2 is a top plan view of a modular laboratory furniture system in accordance with this disclosure having a core unit coupled to two adjustable height tables and four mobile workstations.

FIG. 3 is a front elevational view of the modular laboratory furniture system shown in FIG. 2.

FIG. 4 is a perspective view of the modular laboratory furniture system shown in FIGS. 2 and 3.

FIG. 5 is an exploded perspective view showing the major components of a dry bench core unit that can be used in a modular laboratory furniture system.

FIG. 6 is an exploded perspective view showing the major components of a wet bench core unit that can be used in a modular laboratory furniture system.

FIG. 7 is a side elevational view of a core unit and a chase-way extending upwardly from the core unit.

FIG. 8 is a perspective view of a modified modular laboratory furniture system that has been configured with a sink unit.

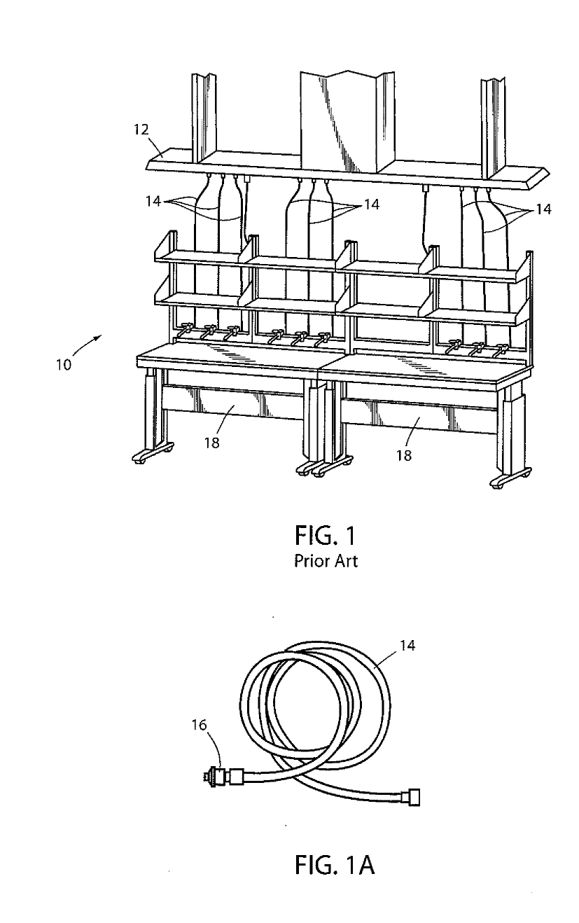

### DETAILED DESCRIPTION

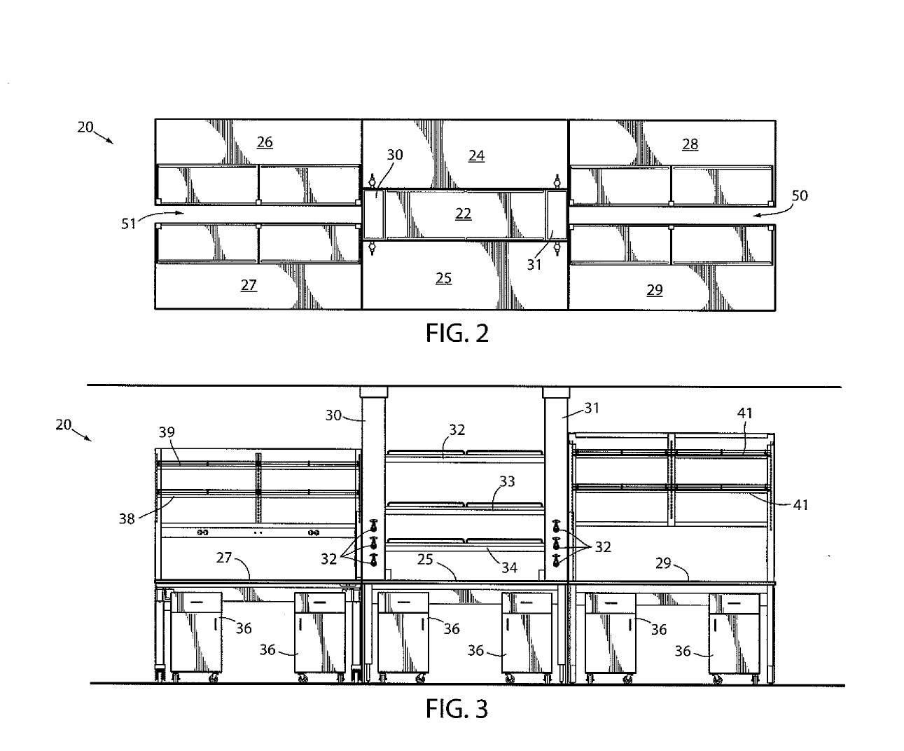

The disclosed modular laboratory furniture systems shown in FIGS. 2-6 can be used in new construction or renovations to provide outstanding flexibility in the ways that the furniture can be easily reconfigured to facilitate changing laboratory needs. These systems also provide laboratory owners and managers with a greater ability to reduce cost and disruption during a laboratory renovation. A variety of different interchangeable modules can be incorporated into the disclosed laboratory furniture systems to reduce or eliminate the need for redesigning facilities during a renovation or reconfiguration of the systems, while meeting various user requirements.

The modular laboratory systems disclosed herein can be configured to allow reconfiguration or renovation with minimal or no plumbing or wiring, and without decoupling modules from building structures or coupling modules to building structures. Modules can be portable or mobile (e.g., provided with wheels or castors) and can be locked in place without coupling the modules to the floors, ceilings or other building structures, such as by using lockable wheels, rollers, or castors, by using removable fasteners (e.g., screws, bolts, etc.) to couple the module(s) to the core unit, or using both lockable wheels or the like and removable fasteners. Services, including gases (such as inert gases or combustible gases), liquids (e.g., water), and electricity can be provided to service fixtures on the modules from the core unit such as via flexible conduits having quick-connect couplings for fluids or by a power cord having a terminal plug received in an electrical outlet. The cords/conduits can be concealed such as in a raceway under a work surface or bench top of a furniture module.

The core unit can be configured for use in both wet and dry laboratories, eliminating the need to distinguish between wet and dry laboratory functions.

The core unit and modules can be provided with wood, metal or plastic laminate surfaces.

The systems disclosed herein eliminate or reduce the need for costly fixed components such as utility bridges or overhead service carriers.

The core unit and laboratory modules that can be coupled to the core unit can be shipped to a site fully assembled with the chase-ways fully pre-plumbed and pre-wired, reducing or eliminating plumbing and electrical installation expenses.

Up to six modules can be docked with a single core unit, with the core unit providing power and other services to the docked modules.

The features of the disclosed laboratory furniture systems reduce initial installation costs and subsequent renovation or reconfiguration costs because modules can be unplugged, easily decoupled from the core unit, and moved as desired. Power and other services can be provided to the core unit via quick-connect couplings either from above the ceiling or from below the core module.

FIGS. 2-4 show an example of a modular laboratory furniture system 20 in accordance with this disclosure. System 20 includes a core unit or module 22, first and second adjustable height tables 24, 25 on opposite long sides of core unit 22, and four mobile (rollable) workstations 26, 27, 28 and 29 positioned adjacent corners of core unit 22.

Chase-ways 30 and 31 extend upwardly from the top of core unit 22 to provide services, such as gases (e.g., air, oxygen, nitrogen, argon) or liquids (e.g., water) via service fittings 32. Chase-ways 30 and 31 can be free-standing, meaning that they are not affixed to building structure, and can be easily removed from core unit 22 to, for example, allow reconfiguration from a dry laboratory to a wet laboratory.

A plurality of shelves 32, 33 and 34 extend between the chase-ways 30 and 31 to provide storage area (e.g., for glassware, chemicals, etc.). At least one shelf is desirable to structurally stabilize chase-ways 30 and 31. Mobile cabinet 36 can be positioned under the work surface or bench top of workstations 26, 27, 28 and 29 and under the work surface or bench top of adjustable height tables 24 and 25 to provide additional storage, such as for files, laboratory notebooks, etc. Workstations 26, 27, 28 and 29 can be provided with shelves 38, 39, 40 and 41. The various shelves 32, 33, 34, 38, 39, 40 and 41 can be provided with rails 42, 43 and 44 at edges thereof and with retainer walls 45 on an opposite edge to prevent objects stored on the shelves from being easily knocked from the shelves.

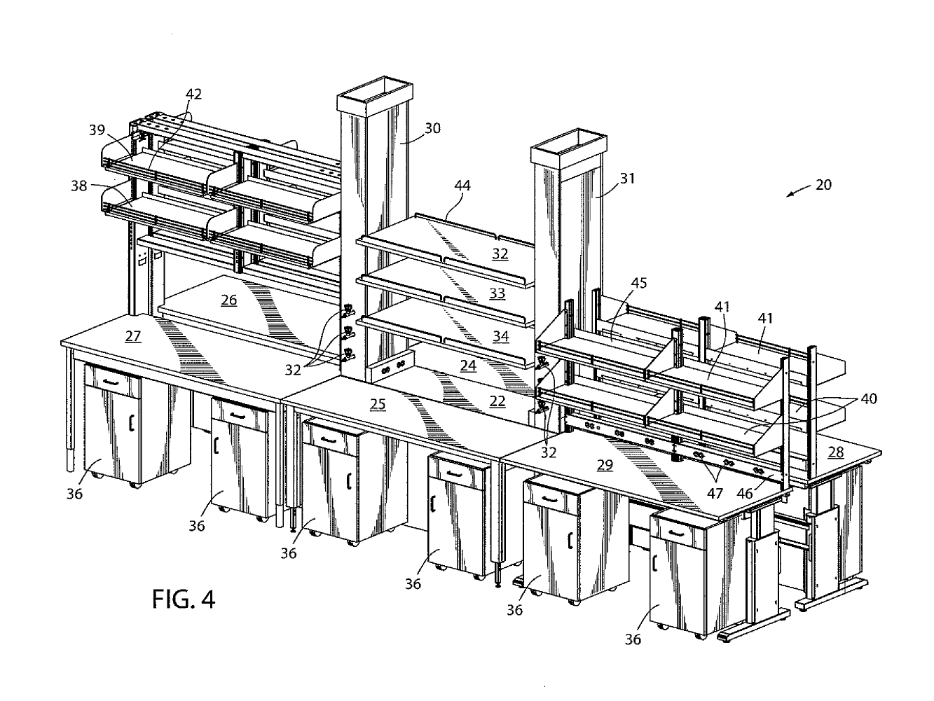

Electrical raceways 46 with electrical outlets 47 (FIG. 4) can be provided on the workstations as desired. These outlets can be powered by an electrical cord extending from a rearward surface (opposite outlets 47) of raceway 46 and having a terminal plug received in an electrical outlet 48 on a vertical raceway 49 disposed on an outward side of the chase-ways 30 and 31.

The power cord for outlets 47 on raceway 46 is located in a gap 50 defined between workstations 28 and 29. A similar gap 51 is provided between workstations 26 and 27 to allow routing of electrical cables or other services.

An electrical raceway 54 with electrical outlets 55 can be provided on the inner walls of chase-ways 30 and 31.

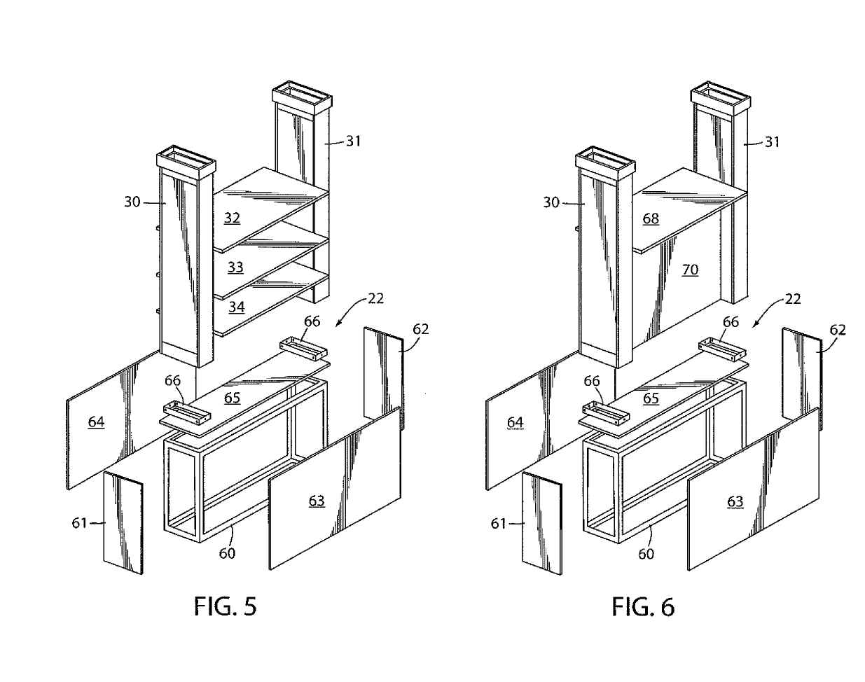

FIGS. 5 and 6 show details of a core unit 22 with either a dry laboratory chase-way arrangement (FIG. 5) or a wet laboratory chase-way arrangement (FIG. 6). In either arrangement, the core includes a frame 60, opposite first and second end panels 61, 62, opposite first and second side panels 63, 64, and a top work surface member 65. Modular system 20 can be installed without attaching any structure other than core unit 22 to building structure. In particular frame 60 can be affixed to the floor of a laboratory. The remaining components of system 20 are mobile or free-standing.

Chase-ways 30 and 31 are coupled to top member 65 of core unit 22 via brackets 66. Brackets 66 can be permanently or removably attached to member 65. Chase-ways 30 and 31 are coupled to brackets 66, such as with screws or other removable fasteners. The chase-way assembly shown in FIG. 6 differs from that of FIG. 5 by having a single connecting shelve 68 and a splash panel 70 for use with a module having a sink, rather than shelves 32, 33 and 34.

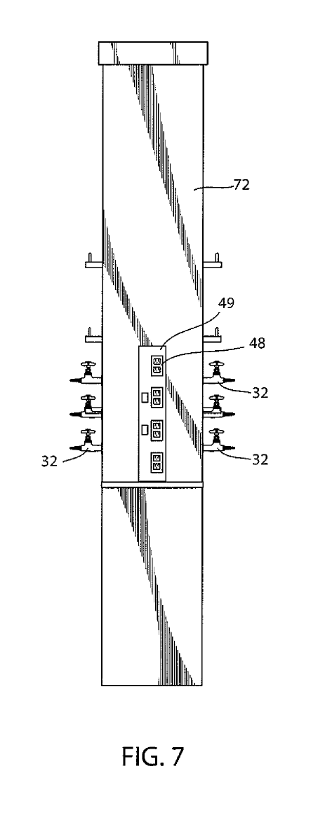

As illustrated in FIG. 7, chase-ways 30 and 31 can include a hinged door or removable access panel 72 on an outer side wall (e.g., the side wall facing away from the opposite chase-way) to facilitate access to the interior of the chase-way. This can be used such as to add another service fitting 32. Service fittings 32 can be of the type typically used in laboratories, and normally include a valve portion and a nozzle portion to which tubing can be temporarily attached.

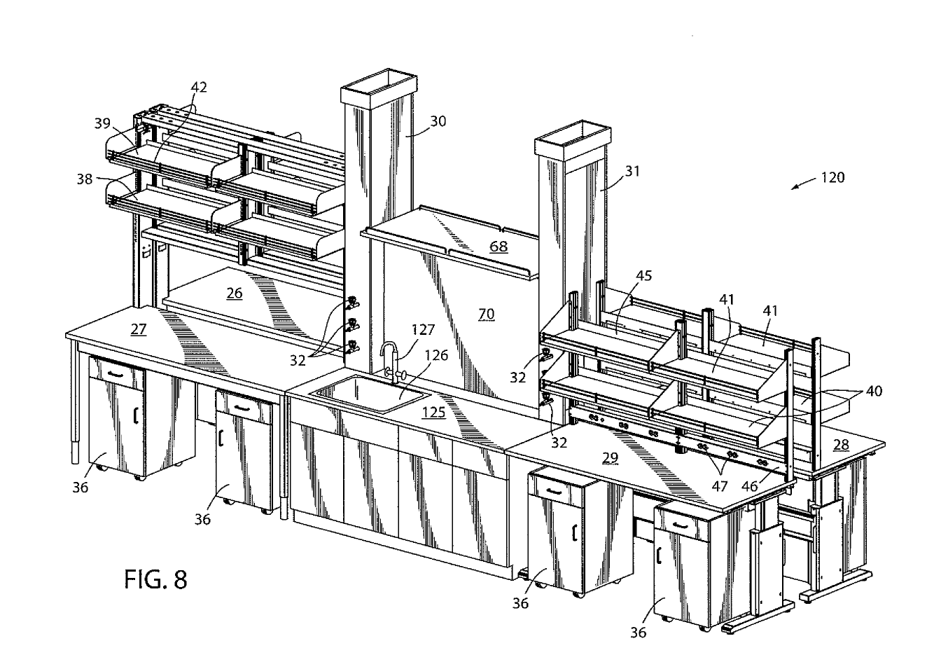

Shown in FIG. 8 is a modular laboratory furniture system 120 substantially identical to furniture system 20 shown in FIG. 4, except that adjustable height table 25 (and optionally adjustable height table 26) is replaced with a modular sink unit 125 having a sink 126 and faucet 127, and the chase-way assembly comprising shelves 32, 33 and 34 (as shown in FIGS. 2-5 and 7) is replaced with the chase-way assembly shown in FIG. 6 having a single shelve 68 and a splash panel 70. This illustrates the convertibility of the modular laboratory systems of this disclosure between so called “wet lab” and “dry lab” configurations. Such conversions can be achieved in a matter of hours.

The above description is considered that of the preferred embodiment(s) only. Modifications of these embodiments will occur to those skilled in the art and to those who make or use the illustrated embodiments. Therefore, it is understood that the embodiment(s) described above are merely exemplary and not intended to limit the scope of this disclosure, which is defined by the following claims as interpreted according to the principles of patent law, including the doctrine of equivalents.

1. A modular laboratory system, comprising:
a core unit having a top member supported on a frame and at least one chase-way projecting upwardly from the top, the at least one chase-way having a plurality of walls that together define an enclosure, at least one service fitting mounted on an exterior side of at least one of the walls of the at least one chase-way, and a conduit connecting the service fitting with a coupling at a top end of the chase-way, whereby a service supply line located above the chase-way can be connected to the coupling to supply a service through the service fitting.

2. The modular laboratory system of claim 1, further comprising a second chase-way, the at least one chase-way and the second chase-way located at opposite ends of the top member.

3. The modular laboratory system of claim 2, further comprising a shelf supported on and extending between the at least one chase-way and the second chase-way.

4. The modular laboratory system of claim 1, further comprising at least one table mounted adjacent an edge of the core unit.

5. The modular laboratory system of claim 4, in which the table is an adjustable height table.

6. The modular laboratory system of claim 1, further comprising a mobile workstation docked to the core unit.

7. The modular laboratory system of claim 6, in which the workstation includes at least one electrical outlet that is electrically connected to a plug that engages and is electrically connected to an electrical supply outlet on the core unit when the workstation is docked to the core unit.

8. The modular laboratory system of claim 1, in which one of the walls includes a door panel to facilitate access to the chase-way.

9. The modular laboratory system of claim 8, in which the door is hinged to one of the walls.

10. The modular laboratory system of claim 8, further comprising a vertically arranged electrical raceway mounted on the door panel to allow opposing workstations to be positioned abuttingly adjacent a side of the core unit.
